(19) United States
(12) Patent Application Publication
(10) Pub. No.: US 2007/0082658 A1
(43) Pub. Date: Apr. 12, 2007

(54) Vehicle on-board unit

(75) Inventors: Steve Tengler, Groose Pointe Park, MI (US); Ronald Heft, Farmington Hills, MI (US)

Correspondence Address: GLOBAL IP COUNSELORS, LLP, 1233 20TH STREET, NW, SUITE 700, WASHINGTON, DC, 20036-2680, US

(73) Assignee: Nissan Technical Center North America, Inc., Farmington Hills, MI (US)

(21) Appl. No.: 11/246,171

(22) Filed: Oct. 11, 2005

(51) Int. Cl. H04B 7/00

(52) U.S. Cl. 455/413; 455/41.2

(57) ABSTRACT

A vehicle on-board unit basically comprises a short range wireless communication section, a voice message download section, a voice message storing section, a notification timing setting section and a notification section. The short range wireless communication section is configured to communicate with a roadside unit located within a prescribed communication region using a short range wireless communication with the roadside unit being linked to a voicemail account of a user. The voice message download section is configured to download voice messages stored in the voicemail account through the short range wireless communication section. The notification timing setting section is configured to set a notification timing for notifying the user that the voice messages were downloaded according to operational conditions of a host vehicle. The notification section is configured to notify the user that the voice messages were downloaded at the notification timing set in the notification timing setting section.

### BACKGROUND OF THE INVENTION

1. Field of the Invention

The present invention generally relates to a vehicle on-board unit. More specifically, the present invention relates to a vehicle on-board unit configured and arranged to download voice messages residing in a user's voicemail account using a short range wireless communication.

2. Background Information

Recently, vehicles are being equipped with a variety of informational systems such as navigation systems, Sirius and XM satellite radio systems, two-way satellite services, built-in cell phones, DVD players and the like. These systems are sometimes interconnected for increased functionality. Various informational systems have been proposed that use wireless communications between vehicles and between infrastructures, such as roadside units. These wireless communications have a wide range of applications ranging from crash avoidance to entertainment systems. The type of wireless communications to be used depends on the particular application. Some examples of wireless technologies that are currently available include digital cellular systems, Bluetooth systems, wireless LAN systems and dedicated short range communications (DSRC) systems.

Dedicated short range communications (DSRC) is an emerging technology that has been recently investigated for suitability in vehicles for a wide range of applications. DSRC technology will allow vehicles to communicate directly with other vehicles and with roadside units to exchange a wide range of information. In the United States, DSRC technology will use a high frequency radio transmission (5.9 GHz) that offers the potential to effectively support wireless data communications between vehicles, and between vehicles, roadside units and other infrastructure. The important feature of DSRC technology is that the latency time between communications is very low compared to most other technologies that are currently available. Another important feature of DSRC technology is the capability of conducting both point-to-point wireless communications and broadcast wireless messages in a limited broadcast area.

Accordingly, DSRC technology can be used to provide various information from vehicle-to/from-infrastructure, and from vehicle-to-vehicle, such as providing GPS location, vehicle speed and other vehicle Parameter Identifiers (PIDs) including engine speed, engine run time, engine coolant temperature, barometric pressure, etc. When communications are established from one vehicle to other vehicles in close proximity, this information would be communicated between the vehicles to provide the vehicles with a complete understanding of the vehicles in the broadcast area. This information then can be used by the vehicles for both vehicle safety applications and non-safety applications.

In vehicle safety applications, a “Common Message Set” (CMS) would mostly likely be developed in which a prescribed set of vehicle Parameter Identifiers (PIDs) are broadcast by each vehicle to give relevant kinematical and location information such as GPS location/vehicle position, vehicle speed, vehicle dimensions etc. Once a potential safety concern is determined to exist, a warning system in the vehicles would notify the driver of the potential safety concern so that the driver can take the appropriate action.

In non-safety applications, a DSRC vehicle on-board unit would most likely provide an encrypted User ID that would coordinate with a specific account on a service provider's look-up table. Once the vehicle on-board unit establishes a link to the service provider, the vehicle on-board unit can be provided with various services associated with the specific account such as point of interest notification, map update download, in-route hotel reservations, etc. through a roadside unit in close proximity that is linked to the service provider.

In view of the above, it will be apparent to those skilled in the art from this disclosure that there exists a need for an improved vehicle on-board unit. This invention addresses this need in the art as well as other needs, which will become apparent to those skilled in the art from this disclosure.

### SUMMARY OF THE INVENTION

In recent years, number of non-safety applications with the vehicle-to-vehicle and vehicle-to/from-infrastructure communications using DSRC technology has been brainstormed. However, voicemail download/coordination using a DSRC vehicle on-board unit has not been developed or proposed. Many voicemail services these days are digital, which means the voice message has been recorded using digital means and can be transferred/shared similarly to a computer file.

Accordingly, one object of the present invention is to provide a vehicle on-board unit that is configured and arranged to download voice messages stored in user's voicemail accounts residing in external service providers using DSRC technology, to notify the user of the voice messages and to process each voice message in accordance with user input.

In order to achieve the above mentioned object and other objects of the present invention, a vehicle on-board unit is provided that basically comprises a short range wireless communication section, a voice message download section, a voice message storing section, a notification timing setting section and a notification section. The short range wireless communication section is configured to communicate with a roadside unit located within a prescribed communication region using a short range wireless communication. The roadside unit is linked to at least one voicemail account of a user. The voice message download section is configured to download voice messages stored in the at least one voicemail account through the short range wireless communication section. The voice message storing section is configured to store the voice messages downloaded by the voice message download section. The notification timing setting section is configured to set a notification timing for notifying the user that the voice messages were downloaded and stored according to operational conditions of a host vehicle equipped with the vehicle on-board unit. The notification section is configured to notify the user that the voice messages were downloaded and stored at the notification timing set in the notification timing setting section.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a pictorial representation of a two-way wireless communications (DSRC) network showing a plurality of vehicles with each being equipped with an vehicle on-board unit capable of conducting two-way wireless communications in accordance with the present invention;

FIG. 2 is a pictorial representation of a two-way wireless communications (DSRC) network showing a host vehicle communicating information from a roadside unit and/or a satellite in accordance with the present invention;

FIG. 3 is a schematic representation of the host vehicle that is equipped with the vehicle on-board unit for conducting two-way wireless communications in accordance with the present invention;

FIG. 4 is a flowchart illustrating the processing executed by a control unit of the vehicle on-board unit to download the voice messages and to notify the user of the voice messages in accordance with the present invention;

FIG. 5 is a flowchart illustrating the voice message reviewing processing executed by the control unit of the vehicle on-board unit to allow the user to review the voice messages downloaded in accordance with the present invention;

FIG. 6 is a flowchart illustrating the user response processing executed by the control unit of the vehicle on-board unit to process one of the voice messages based on the user input in accordance with the present invention;

FIG. 7 is a simplified schematic view of a display screen of the vehicle on-board unit illustrating an example of a display for coordinating various voicemail accounts of a user in accordance with the present invention;

FIG. 8 is a simplified schematic view of the display screen of the vehicle on-board unit illustrating an example of a display for setting a notification timing for one of the voicemail accounts of the user in accordance with the present invention;

FIG. 9 is a simplified schematic view of the display screen of the vehicle on-board unit illustrating an example of a display shown when the user is notified of the voice messages at the notification timing in accordance with the present invention;

FIG. 10 is a simplified schematic view of the display screen of the vehicle on-board unit illustrating an example of a display for prompting the user to listen to one of the voice messages in accordance with the present invention; and

FIG. 11 is a simplified schematic view of the display screen of the vehicle on-board unit illustrating an example of a display for prompting the user to respond to the one of the voice messages in accordance with the present invention.

### DETAILED DESCRIPTION OF THE PREFERRED EMBODIMENTS

Selected embodiments of the present invention will now be explained with reference to the drawings. It will be apparent to those skilled in the art from this disclosure that the following description of the embodiment of the present invention is provided for illustration only and not for the purpose of limiting the invention as defined by the appended claims and their equivalents.

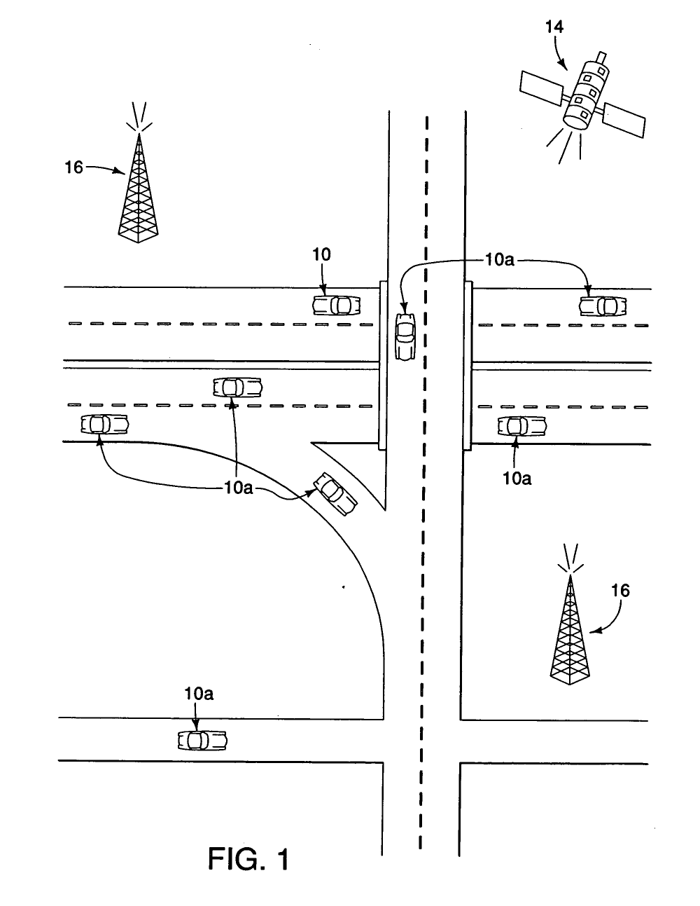

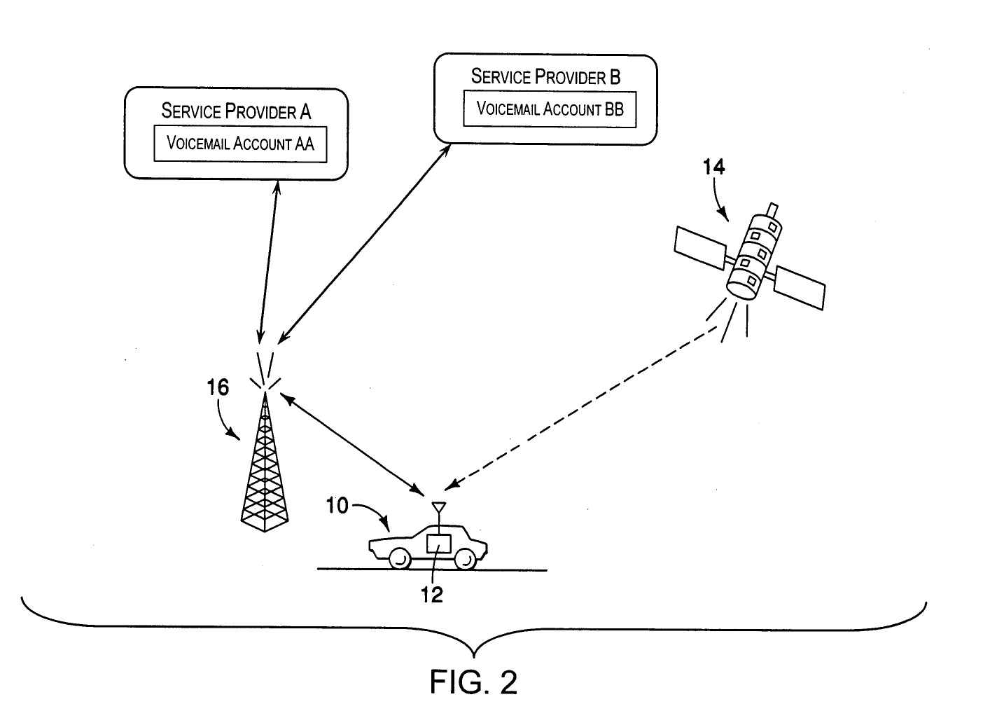

Referring initially to FIGS. 1 and 2, a two-way wireless communications network is illustrated in which a host vehicle 10 is equipped with a vehicle on-board unit 12 in accordance with a preferred embodiment of the present invention. Several neighboring or nearby vehicles 10a are also preferably each equipped with a DSRC on-board unit so that information can be communicated among the host vehicle 10 and the nearby vehicles 10a within the two-way wireless communications network. The two-way wireless communications network also includes one or more roadside units 16 (only two shown) that is configured and arranged to send and receive signals to and from the vehicles 10 and 10a. More specifically, each roadside unit 16 is equipped with a DSRC unit for broadcasting and receiving signals to the vehicles 10 and 10a located with a prescribed communication (broadcasting/receiving) region surrounding the roadside unit 16. Moreover, each roadside unit 16 is preferably an IP enabled infrastructure that is configured and arranged to establish a link between the vehicle on-board unit 12 of the host vehicle 10 and an external service provider. Such roadside unit is a conventional component that is known in the art. Since the roadside unit is known in the art, the structures of the roadside units 16 will not be discussed or illustrated in detail herein. Rather, it will be apparent to those skilled in the art from this disclosure that the roadside unit can be any type of structure that can be used to carry out the present invention.

Specifically, in the present invention, the roadside unit 16 is configured and arranged to establish a link between the vehicle on-board unit 12 of the vehicle 10 and at least one service provider that has a voicemail account of a user of the vehicle on-board unit 12. An example is shown in FIG. 2 in which the vehicle on-board unit 12 of the vehicle 10 establishes a link to a voicemail account AA in a service provider A and a voicemail account BB in a service provider B through the roadside unit 16 in close proximity. The service providers A and B are, for example, telecommunications providers. The vehicle on-board unit 12 is configured and arranged to download voice messages from the voicemail account AA and the voicemail account BB through the roadside unit 16. More specifically, upon entering the domain of the roadside unit 16, the vehicle on-board unit 12 is configured and arranged to send an encrypted user ID to the service providers A and B, which is coordinated with a specific voicemail account (e.g., the voicemail account AA or BB) on each service provider's look-up table. Then, the vehicle on-board unit 12 is configured and arranged to establish a link such that a file (e.g., voicemail packet(s)) can be downloaded from the voicemail accounts AA and BB through the road side unit 16.

As shown in FIGS. 1 and 2, the two-way wireless communications can further include one or more global positioning satellites 14 (only one shown). The global positioning satellite 14 is a conventional component that is known in the art. Since the global positioning satellite is known in the art, the structures of the global positioning satellite 14 will not be discussed or illustrated in detail herein. Rather, it will be apparent to those skilled in the art from this disclosure that the global positioning satellite 14 can be any type of structure that can be used to carry out the present invention.

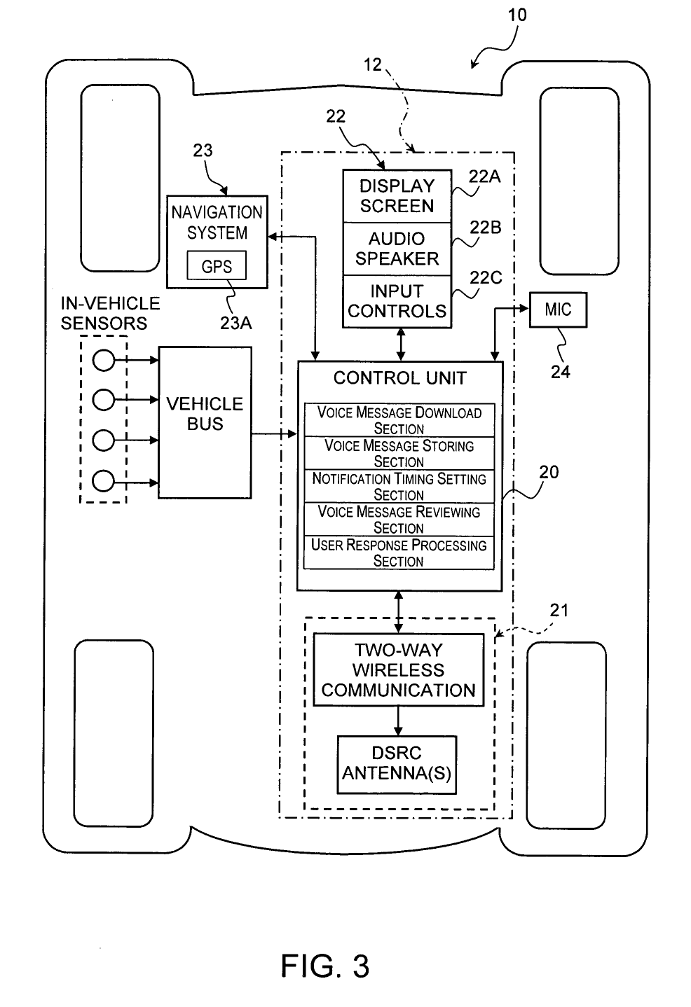

Referring now to FIG. 3, the vehicle on-board unit 12 of the present invention basically includes a controller or control unit 20, a two-way wireless communications system 21 (a short range wireless communication section), and a notification section 22. Moreover, the control unit 20 of the vehicle on-board unit 12 is configured to receive detection signals from various in-vehicle sensors including but not limited to a vehicle speed sensor, an acceleration sensor, an accessory switch sensor, etc. Also, the vehicle on-board unit 12 of the present invention can be coupled to a navigation system 23. The navigation system 23 is preferably a conventional navigation system that is configured and arranged to receive global positioning information of the vehicle 10 through a global positioning system (GPS) 23A based on the signals transmitted from the global positioning satellites 14. Furthermore, the vehicle on-board unit 12 is preferably coupled to a factory-installed microphone 24 that is configured and arranged to record a voice messages of the user.

The control unit 20 of the vehicle on-board unit 12 includes a program that has a voice message download section or component, a notification timing setting section or component, a voice message reviewing section or component and a user response processing section or component. The control unit 20 also includes a voice message storing section or component. The voice message download section is configured to download voice messages residing in the user's voicemail accounts (e.g., the voicemail accounts AA and BB) in the external service providers (e.g., the service providers A and B) through the roadside unit 16. The voice message storing section is configured to store the downloaded voice messages. Although the voice message storing section is shown in FIG. 1 as part of the control unit 20, it will be apparent to those skilled in the art from this disclosure that an external storage component that is operatively coupled to the control unit 20 can also be used as the voice message storing section. The notification timing setting section is configured to set a notification timing for notifying the user that the voice messages were downloaded and stored according to operational conditions of the vehicle 10. The voice message reviewing section is configured to provide the user of the vehicle on-board unit 12 with a plurality of review operation options for reviewing the voice messages stored in the voice message storing section. The user response processing section is configured to provide the user of the vehicle on-board unit 12 with a plurality of response operation options for processing one of the voice messages stored in the voice message storing section. The user response processing section is further configured to process the voice message in accordance with the response operation option selected by the user.

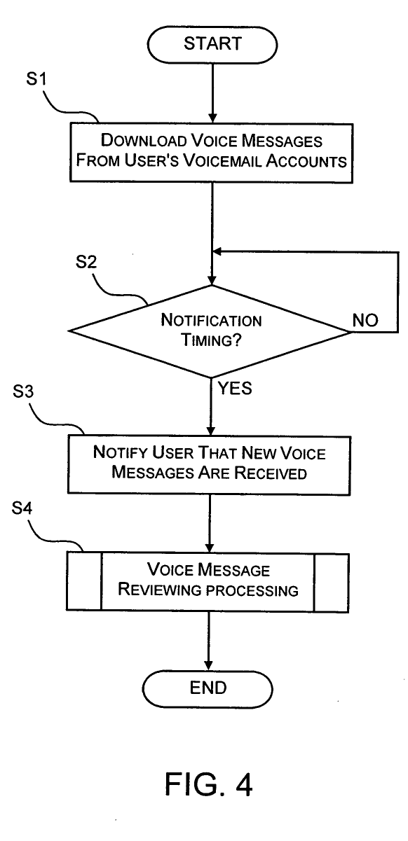

The control unit 20 is configured and/or programmed to execute the processing in the voice message download section, the voice message storing section, the notification timing setting section, the voice message reviewing section and the user response processing section by executing the steps shown in the flow charts of FIGS. 4 to 6 (discussed below) in conjunction with various signals to and from the other components and systems such as the in-vehicle sensors and the navigation system 23.

The control unit 20 preferably includes a microcomputer with a voicemail download/coordination control program in accordance with the present invention. The control unit 20 also preferably includes other conventional components such as an input interface circuit, an output interface circuit, and storage devices such as a ROM (Read Only Memory) device and a RAM (Random Access Memory) device. The memory circuit stores processing results and control programs such as ones for operation of the two-way wireless communications system 21 that are run by the processor(s). The control unit 20 is capable of selectively controlling any of the components of the vehicle on-board unit 12 as needed and/or desired. It will be apparent to those skilled in the art from this disclosure that the precise structure and algorithms for the control unit 20 can be any combination of hardware and software that will carry out the functions of the present invention. In other words, “means plus function” clauses as utilized in the specification and claims should include any structure or hardware and/or algorithm or software that can be utilized to carry out the function of the “means plus function” clause.

The two-way wireless communications system 21 includes communication interface circuitry that connects and exchanges information with a plurality of the nearby vehicles 10a that are similarly equipped with the two-way wireless communications system as well as with the roadside units 16 through a wireless network within the broadcast range of the host vehicle 10. The two-way wireless communications system 21 is configured and arranged to conduct direct two way communications between the host vehicle 10 and the nearby vehicles 10a (vehicle-to-vehicle communications) and the roadside units 16 (roadside-to-vehicle communications). Moreover, the two-way wireless communications system 21 is configured to periodically broadcast a signal in the broadcast area. The two-way wireless communications system 21 preferably has both an omni-directional antenna and a multi-directional antenna.

In particular, the two-way wireless communications system 21 is preferably a dedicated short range communications systems, since the latency time between communications is very low compared to most other technologies that are currently available. However, other two-way wireless communications systems can be used if they are capable of conducting both point-to-point wireless communications and broadcast wireless messages in a limited broadcast area so log as the latency time between communications is short enough. When the two-way wireless communications system 21 is a DSRC system, the two-way wireless communications system 21 will transmit at a 75 Mhz spectrum in a 5.9 GHz band with a data rate of 1 to 54 Mbps, and a maximum range of about 1,000 meters. Preferably, the two-way wireless communications system 21 includes seven (7) non-overlapping channels. The two-way wireless communications system 21 will be assigned a Medium Access Control (MAC) address and/or an IP address so that each vehicle in the network can be individually identified.

The notification section 22 preferably includes a display screen 22A, an audio speaker 22B, and an input controls 22C. The notification section 22 constitutes a human machine interface by which the user interacts with the vehicle on-board unit 12. Thus, the notification section 22 is configured and arranged to allow the vehicle on-board unit 12 to inform the user by using the display screen 22A and/or the audio speaker 22B, and to allow the user to control the vehicle on-board unit 12 by accepting user input through the input controls 22C.

Referring now to the flowchart of FIG. 4, the control processing executed by the control unit 20 to download the voice messages and to notify the user will be explained. As mentioned above, upon the vehicle 10 entering the domain of the roadside unit 16, the vehicle on-board unit 12 is configured to establish a link with the external service providers (e.g., the service providers A and B in FIG. 2) such that a file (e.g., voicemail packet(s)) can be downloaded from the user's voicemail accounts (e.g. the voicemail accounts AA and BB) through the two-way wireless communication system 21 and the roadside unit 16.

In step S1 of FIG. 4, the control unit 20 is configured to download the voice messages residing in the user's voicemail accounts (the voice message download section) and to temporarily store the downloaded voice messages in the voice message storing section. The voice message storing section is preferably configured to store the voice messages in association with the corresponding voicemail account of the user from which the voice messages were downloaded so that the voice messages will be presented to the user in relation to the corresponding voicemail account. With this arrangement, the voice messages downloaded from multiple voicemail accounts of the user can be coordinated in the vehicle on-board unit 12.

Next, in step S2, the control unit 20 is configured and arranged to determine whether a notification timing for any one of the voicemail accounts from which the voice messages were downloaded has occurred. The notification timing is preferably determined in advance for notifying the user of the vehicle on-board unit 12 that the voice messages were downloaded and stored.

More specifically, in the present invention, the notification timing is preferably set by the user in advance according to the operational conditions of the vehicle 10. For example, the user of the vehicle on-board unit 12 can select one or more operational conditions as the notification timing, which indicate that the vehicle 10 is in a safe environment for the user to be notified of the voice messages (e.g., when the vehicle 10 is parked, when the vehicle 10 is traveling at a speed lower than a prescribed speed, and when an accessory switch of the vehicle 10 is turned on). Alternatively, the user can simply set the notification timing to the operation conditions indicating the vehicle 10 is traveling at any speed so that the user is notified immediately after the voice messages are downloaded. Moreover, in the present invention, the user of the vehicle on-board unit 12 can set different notification timings for different voicemail accounts so that specific filters are created with respect to the notification timing for each voicemail account.

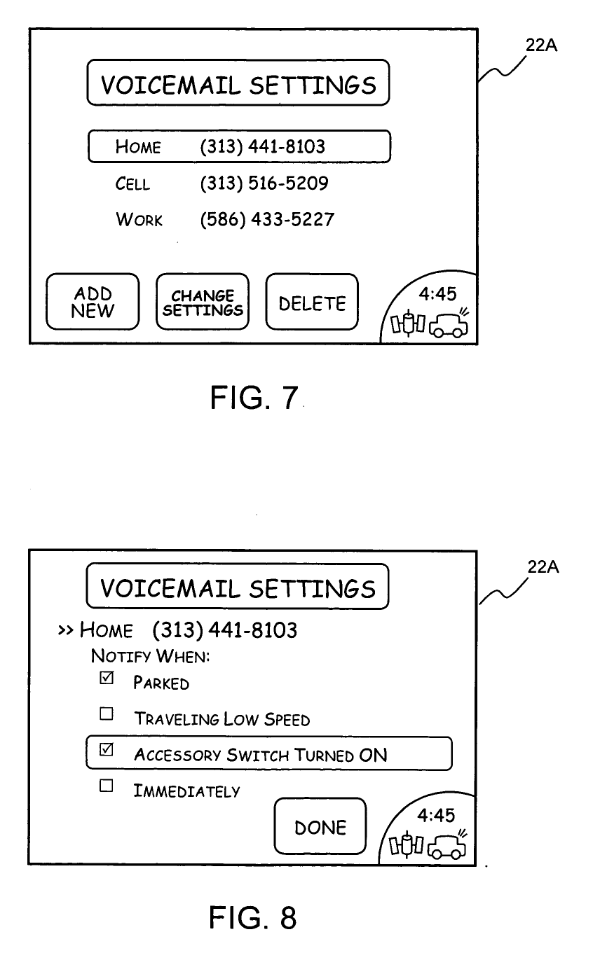

FIGS. 7 and 8 illustrate examples of displays shown in the display screen 22A of the vehicle on-board unit 12 when the user sets the notification timing. In the case shown in FIG. 7, the user has set up three different voicemail accounts (i.e., home, cellular, and work) from which the voice messages are downloaded to the vehicle on-board unit 12 through the two-way wireless communication system 21. When the user sets the notification timing, the user is allowed to select one or more operational conditions of the vehicle 10 for each voicemail account, which include when the vehicle 10 is parked, when the vehicle 10 is traveling low speed (e.g., the vehicle speed is below a prescribe threshold speed for more than a prescribed seconds), when the accessory switch of the vehicle 10 is turned on, and when the vehicle 10 is traveling at any speed (i.e., immediately) as shown in FIG. 8. Therefore, by changing the operational conditions for the notification timing in each voicemail account, the user can set up the voicemail notification such that, for example, the user is notified of only the voice messages in the user's work voicemail account if the vehicle 10 is traveling in a high speed.

It will be apparent to those skilled in the art from this disclosure that the operational conditions for setting the notification timing are not limited to the conditions explained herein. For example, any operational conditions that can be detected based on the detection signals from the in-vehicle sensors (e.g., the vehicle speed, the accessory switch turned on, etc.) or based on information obtained by the navigation system 23 (e.g., the vehicle 10 entered in a parking lot, the vehicle 10 driving in a low speed limit zone, etc.) may be used to set the notification timing.

Referring back to FIG. 4, when the control unit 20 determines in step S2 that the notification timing for any one of the voicemail accounts from which the voice messages were downloaded has occurred based on the detection signals from the in-vehicle sensors and/or information obtained by the navigation system 23 (YES in step S2), the control unit 20 is configured to proceed to step S3. In step S3, the control unit 20 is configured to notify the user of the vehicle on-board unit 12 that the new voice messages are received (i.e., downloaded and stored) from the corresponding voicemail account(s) by using the notification section 22.

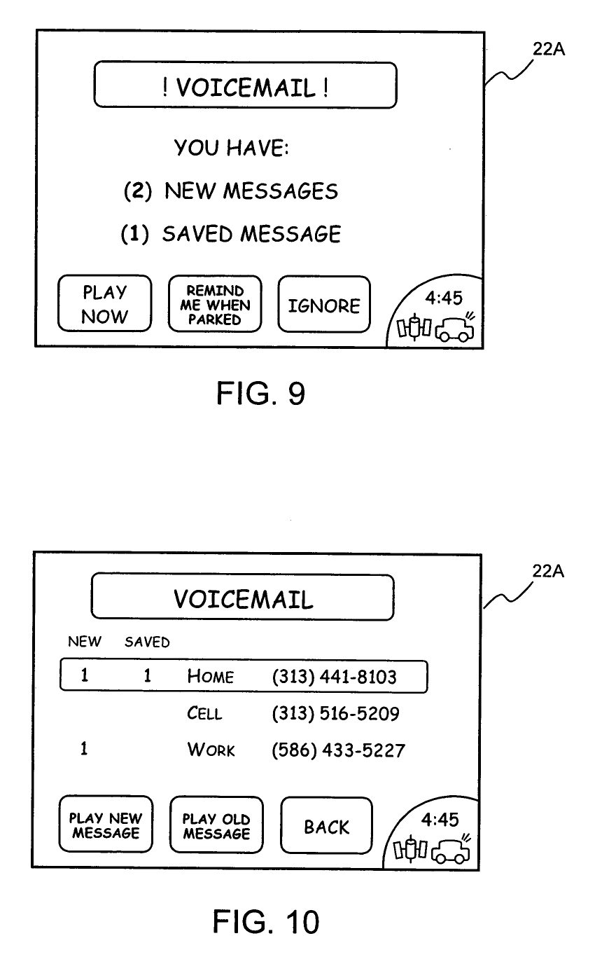

The notification to the user in step S3 can occur in various manners. For example, FIG. 9 illustrates an example of a display shown in the display screen 22A of the vehicle on-board unit 12 when the user is notified of the voice messages. In the example shown in FIG. 9, a high-resolution screen shows up on the display screen 22A to alert the user and provide immediate options for reviewing the voice messages. In addition, an audible tone such as a simple beep is preferably issued from the audio speaker 22B of the vehicle on-board unit 12 to alert the user of the new voicemail arrival. Of course, it will be apparent to those skilled in the art from this disclosure that the manner of voicemail notification is not limited to the examples explained herein. For example, instead of the high-resolution screen display illustrated in FIG. 9, a visible icon (e.g., an envelope icon with sound waves, a phone icon with “!” beside it, and the like) can appear in the cluster in the display screen 22A to notify the user that new voice messages were arrived. Moreover, an audible spoken phrase may be used instead of or in addition to the audible tone such that a pleasant voice announces “new voicemail” or some other phrase indicating the new voice messages are arrived.

When the user is notified that the new voice messages are received in the specific voicemail account(s) in step S3, the control unit 20 is configured to provide the user with a plurality of review operation options for reviewing the voice messages stored in the voice message storing section. For example, the control unit 20 is configured to display in the display screen 22A of the notification section 22 three review operation options including a play operation option (“play now”), a remind operation option (“remind me when parked”), and an ignore operation option (“ignore”) as shown in FIG. 9. Of course, it will be apparent to those skilled in the art from this disclosure that the review operation options are not limited to the ones explained herein. Any appropriate operations in response to the downloaded voice messages can be used to carry out the present invention.

Then, in step S4 of FIG. 4, the control unit 20 is configured to execute the voice message reviewing processing in accordance with the review operation option selected by the user.

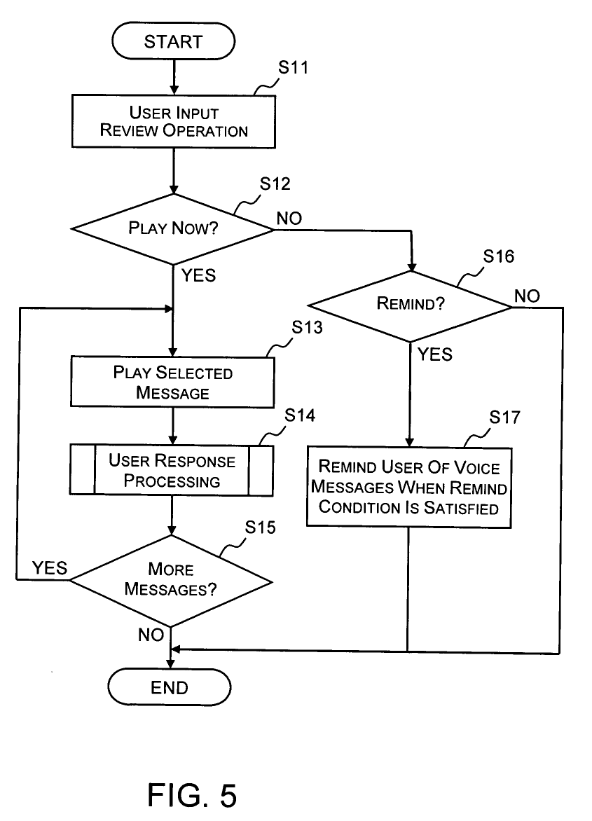

A control flow of the voice message reviewing processing is shown in the flow chart of FIG. 5. In step S11, the control unit 20 is configured to accept user input for the review operation option that is inputted by using the input controls 22C of the notification section 22. Then, in step S12, the control unit 20 is configured to determine whether the review operation option inputted by the user is the play operation option (“play now”). If the review operation option inputted by the user is the play operation option, the control unit 20 proceeds to step S13.

In step S13, the control unit 20 is configured to prompt the user to select one of the voice messages downloaded in the specific voicemail account (FIG. 10) and to play the voice message selected by the user. The control unit 20 is preferably configured to display or audibly announce the information relating to the voice message (such as a caller number, a call time, a call date, and the like) before, during or after the voice message is played.

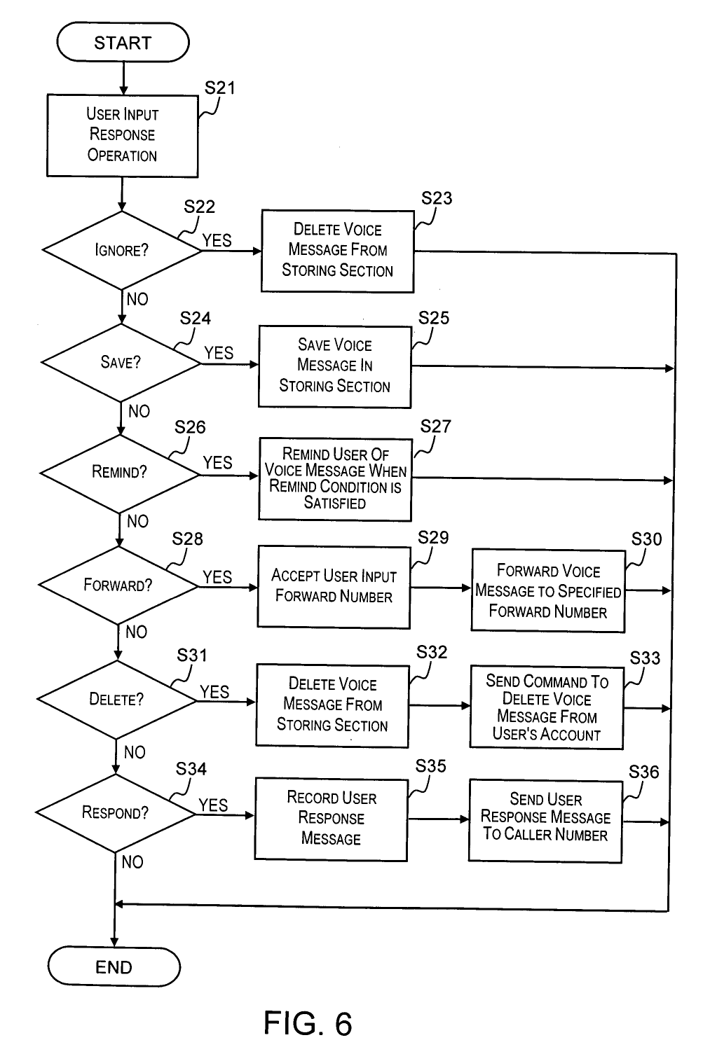

After the user reviews the voice message, the control unit 20 is configured to execute a user response processing with respect to the reviewed voice message in step S14. The user response processing will be discussed in detail below with referring to the flowchart of FIG. 6.

In step S15, the control unit 20 is configured to check if there is any voice massage associated with the specific voicemail account that is left in the voice message storing section and that has not been reviewed by the user. If there is no voice message that is not reviewed by the user in the voice message storing section in step S15, the control unit 20 is configured to end the voice message reviewing processing. If there is a voice message or messages associated with the specific voicemail account in the voice message storing section in step S15, the control unit 20 is configured to repeat steps S13 and S14 for each voice message associated with the specific voicemail account until there is no voice message left in the voice message storing section.

If the review operation option inputted by the user is not the play operation option (“play now”) in step S12, the control unit 20 proceeds to step S16. In step S16, the control unit 20 is configured to determine whether the review operation option inputted by the user is the remind operation option (“reminder me when parked”).

If the review operation option inputted by the user is the remind operation option in step S16 (YES in step S16), the control unit 20 proceeds to step S17. In step S17, the control unit 20 is configured to remind the user of the voice messages by using the notification section 22 when a remind condition is satisfied. In the case illustrated in FIG. 7, the remind condition is set to when the vehicle 10 is parked. However, it will be apparent to those skilled in the art from this disclosure that remind condition can be set in advance to one or more of the operation conditions of the vehicle 10 including, for example, when the vehicle 10 is parked, when a prescribed period of time has elapsed, when the vehicle 10 is traveling at a speed below a prescribed threshold speed, and the like. Whether the remind condition has been satisfied or not is preferably determined based on the detection signals from the in-vehicle sensors and/or the information obtained by the navigation system 23.

If the review operation option inputted by the user is not the remind operation option in step S16 (NO in step S16), the control unit 20 is configured to end the voice message reviewing processing since this case occurs when the user selected the ignore operation option (“ignore”).

Referring now to the flowchart of FIG. 6, the user response processing in step S14 of the flowchart of FIG. 5 will be described in more detail.

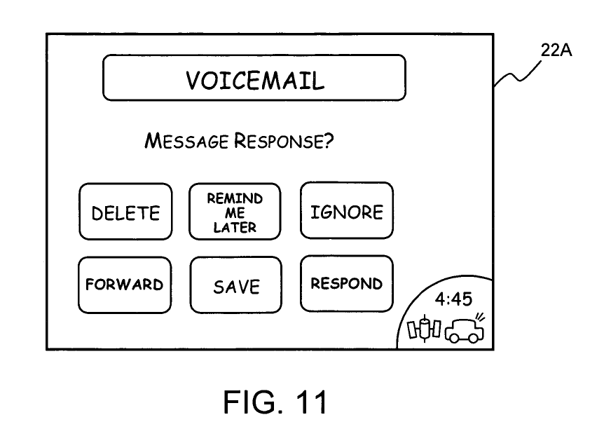

After the user reviews the selected voice message in step S13 in the flowchart of FIG. 5, the control unit 20 is configured to provide the user with a plurality of user response operation options. FIG. 11 illustrates an example of a display shown in the display screen 22A of the vehicle on-board unit 12 after the user reviewed the selected voice message. In the case shown in FIG. 11, the user is provided with six user response operation options for processing the selected voice message including a message ignore operation option (“ignore”), a delete operation option (“delete”), a forward operation option (“forward”), a save operation option (“save”), a message remind operation option (“remind me later”) and a respond operation option (“respond”).

In step S21 of FIG. 6, the control unit 20 is configured to accept a user input selecting one of the user response operation options. In step S22, the control unit 20 is configured to determine whether the user response operation option selected by the user is the message ignore operation option (“ignore”). If the control unit 20 determines that the user selected the message ignore operation option in step S22 (YES in step S22), the control unit 20 proceeds to step S23. In step S23, the control unit 20 is configured to delete the selected voice message from the voice message storing section. Then, the control unit 20 is configured to end the user response processing with respect to the selected voice message.

If the control unit 20 determines in step S22 that the user response operation option selected by the user is not the message ignore operation option (NO in step S22), the control unit 20 proceeds to step S24. In step S24, the control unit 20 is configured to determine whether the user response operation option selected by the user is the save operation option (“save”). If the control unit 20 determines that the user selected the save operation option in step S24 (YES in step S24), the control unit 20 proceeds to step S25. In step S25, the control unit 20 is configured to save the selected voice message in the voice message storing section. Then, the control unit 20 is configured to end the user response processing with respect to the selected voice message.

If the control unit 20 determines in step S24 that the user response operation option selected by the user is not the save operation option (NO in step S24), the control unit 20 proceeds to step S26. In step S26, the control unit 20 is configured to determine whether the user response operation option selected by the user is the message remind operation option (“remind me later”). If the control unit 20 determines that the user selected the message remind operation option in step S26 (YES in step S26), the control unit 20 proceeds to step S27. In step S27, the control unit 20 is configured to remind the user of the selected voice message when a remind condition is satisfied. Then, the control unit 20 is configured to end the user response processing with respect to the selected voice message.

The remind condition is preferably set in advance to one or more of the operation conditions of the vehicle 10 including, for example, when the vehicle 10 is parked, when a prescribed period of time has elapsed, when the vehicle 10 is traveling at a speed below a prescribed threshold speed, and the like. Whether the remind condition has been satisfied or not is preferably determined based on the detection signals from the in-vehicle sensors and/or the information obtained by the navigation system 23.

If the control unit 20 determines in step S26 that the user response operation option selected by the user is not the message remind operation option (NO in step S26), the control unit 20 proceeds to step S28. In step S28, the control unit 20 is configured to determine whether the user response operation option selected by the user is the forward operation option (“forward”). If the control unit 20 determines that the user selected the forward operation option in step S28 (YES in step S28), the control unit 20 proceeds to step S29. In step S29, the control unit 20 is preferably configured to prompt the user to input a location or forward number to which the selected voice message is forwarded, and accept the user input for the forward number. Then, in step S30, the control unit 20 is configured to forward the selected voice message to the specified forward number using the two-way wireless communication system 21. Then, the control unit 20 is configured to end the user response processing with respect to the selected voice message. Of course, the vehicle on-board unit 12 can be configured and arranged such that the forward number is selected in advance by the user and stored in the control unit 20. In such case, step S29 can be omitted so that the selected voice message is automatically forwarded to the pre-selected forward number without prompting the user input upon the user selecting the forward response operation option. Moreover, the vehicle on-board unit 12 can be configured and arranged to permit the user to record an add-on message to the selected voice message before forwarding the selected voice message by using the microphone 24. Then, the control unit 20 is configured to end the user response processing with respect to the selected voice message.

If the control unit 20 determines in step S28 that the user response operation option selected by the user is not the forward operation option (NO in step S28), the control unit 20 proceeds to step S31. In step S31, the control unit 20 is configured to determine whether the user response operation option selected by the user is the delete operation option (“delete”). If the control unit 20 determines that the user selected the delete operation option in step S31 (YES in step S31), the control unit 20 proceeds to step S32. In step S32, the control unit 20 is configured to delete the selected voice message from the voice message storing section. Then, the control unit 20 is configured establish a link to the service provider from which the selected message was downloaded through the two-way wireless communication system 21 and the roadside unit 16 within the communication region of the two-way wireless communication system 21. Next, in step S32, the control unit 20 is configured to send a command to the service provider to delete the selected voice message from the user's voicemail account. Then, the control unit 20 is configured to end the user response processing with respect to the selected voice message.

If the control unit 20 determines in step S31 that the user response operation option selected by the user is not the delete operation option (NO in step S31), the control unit 20 proceeds to step S34. In step S34, the control unit 20 is configured to determine whether the user response operation option selected by the user is the respond operation option (“respond”). If the control unit 20 determines that the user selected the respond operation option in step S34 (YES in step S34), the control unit 20 proceeds to step S35. In step S35, the control unit 20 is configured to allow the user to record a user response message in response to the selected voice message by using the microphone 24. Next, in step S36, the control unit 20 is configured to send the recorded user response message to a designated location (e.g., an originating number of the selected voice message) through the two-way wireless communication system 21 and the roadside unit 16 within the communication region of the two-way wireless communication system 21. Then, the control unit 20 is configured to end the user response processing with respect to the selected voice message.

If the control unit 20 determines in step S34 that the user response operation option selected by the user is not the respond operation option (NO in step S34), the control unit 20 is configured to end the user response processing.

Accordingly, with the vehicle on-board unit 12 in accordance with the present invention, upon the vehicle 10 entering the domain of the IP-enabled roadside unit 16, the vehicle on-board unit 12 will be informed that the services from the service providers are available and will establish a link with the service providers such that a file (e.g., voicemail packet(s)) can be downloaded and temporarily stored in the vehicle on-board unit 12. Once the new voice messages are received, the vehicle on-board unit 12 is configured to provide notification to the user. Although the user may believe voicemail to be urgent enough to receive notification while driving the vehicle 10, the user may not wish to review the content until parked and/or located in a safe position. Therefore, the user is provided with the option and/or automatic filter to await the notification of the voice messages until the notification timing occurs. In the present invention, the notification timing can be selected by the user in accordance with the operating conditions of the vehicle 10. Accordingly, with the present invention, the user can receive urgent information in a timely and safe manner.

Moreover, with the vehicle on-boar unit 12 of the present invention, the voice messages can be downloaded from a plurality of voicemail accounts of the user residing in a plurality of service providers so that the multiple voicemail accounts can be coordinated in the vehicle on-board unit 12. The user of the vehicle on-board unit 12 is allowed to select different notification timing for each voicemail account. Furthermore, with the vehicle on-board unit 12 of the present invention, the user is given the option of responding to a voice message after reviewing the voice message.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function. The term “configured” as used herein to describe a component, section or part of a device includes hardware and/or software that is constructed and/or programmed to carry out the desired function. Moreover, terms that are expressed as “means-plus function” in the claims should include any structure that can be utilized to carry out the function of that part of the present invention. The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A vehicle on-board unit comprising:
a short range wireless communication section configured to communicate with a roadside unit located within a prescribed communication region using a short range wireless communication, the roadside unit being linked to at least one voicemail account of a user;
a voice message download section configured to download voice messages stored in the at least one voicemail account through the short range wireless communication section;
a voice message storing section configured to store the voice messages downloaded by the voice message download section;
a notification timing setting section configured to set a notification timing for notifying the user that the voice messages were downloaded and stored according to operational conditions of a host vehicle equipped with the vehicle on-board unit; and
a notification section configured to notify the user that the voice messages were downloaded and stored at the notification timing set in the notification timing setting section.

2. The vehicle on-board unit as recited in claim 1, wherein
the notification timing setting section is further configured to allow the user to select the operational conditions of the host vehicle for setting the notification timing.

3. The vehicle on-board unit as recited in claim 1, wherein
the notification timing setting section is further configured to set the notification timing according to the operational conditions of the host vehicle indicating that the host vehicle is in a safe environment for the user to be notified of the voice messages.

4. The vehicle on-board unit as recited in claim 1, wherein
the notification timing setting section is further configured to set the notification timing to at least one of when the host vehicle is parked, when the host vehicle is traveling at a speed lower than a prescribed speed, and when an accessory switch of the host vehicle is turned on.

5. The vehicle on-board unit as recited in claim 1, further comprising
a voice message reviewing section configured to provide the user with a plurality of review operation options for reviewing the voice messages stored in the voice message storing section.

6. The vehicle on-board unit as recited in claim 5, wherein
the voice message reviewing section is configured to provide the user with a play operation option as one of the review operation options, the voice message reviewing section being further configured to play back the voice messages to the user when the user selects the play operation option among the review operation options.

7. The vehicle on-board unit as recited in claim 5, wherein
the voice message reviewing section is configured to provide the user with a remind operation option as one of the review operation options, the voice message reviewing section being further configured to remind the user of the voice messages upon a remind condition being satisfied when the user selects the remind operation option among the review operation options.

8. The vehicle on-board unit as recited in claim 7, wherein
the voice message reviewing section is configured to provide the user with an ignore operation option as one of the review operation options, the voice message reviewing section being further configured to end a review operation of the voice messages when the user selects the ignore operation option among the review operation options.

9. The vehicle on-board unit as recited in claim 1, further comprising
a user response processing section configured to provide the user with a plurality of response operation options for processing one of the voice messages stored in the voice message storing section, the user response processing section being further configured to process the one of the voice messages in accordance with one of the response operation options selected by the user.

10. The vehicle on-board unit as recited in claim 9, wherein
the user response processing section is configured to provide the user with a respond operation option as one of the response operation options, the user response processing section being further configured to send a user response message to a designated location through the short range wireless communication section when the user selects the respond operation option among the response operation options.

11. The vehicle on-board unit as recited in claim 9, wherein
the user response processing section is configured to provide the user with a message ignore operation option as one of the response operation options, the user response processing section being further configured to delete the one of the voice messages from the voice message storing section when the user selects the message ignore operation option among the response operation options.

12. The vehicle on-board unit as recited in claim 9, wherein
the user response processing section is configured to provide the user with a delete operation option as one of the response operation options, the user response processing section being further configured to delete the one of the voice messages from the voice message storing section and to send a command to delete the one of the voice messages from the at least one voicemail account of the user through the short range wireless communication section when the user selects the delete operation option among the response operation options.

13. The vehicle on-board unit as recited in claim 9, wherein
the user response processing section is configured to provide the user with a forward operation option as one of the response operation options, the user response processing section being further configured to forward the one of the voice messages to a designated location through the short range wireless communication section when the user selects the forward operation option among the response operation options.

14. The vehicle on-board unit as recited in claim 9, wherein
the user response processing section is configured to provide the user with a save operation option as one of the response operation options, the user response processing section being further configured to save the one of the voice messages in the voice message storing section when the user selects the forward operation option among the response operation options.

15. The vehicle on-board unit as recited in claim 9, wherein
the user response processing section is configured to provide the user with a message remind operation option as one of the response operation options, the user response processing section being further configured to remind the user of the one of the voice messages upon a message remind condition being satisfied when the user selects the message remind operation option among the response operation options.

16. The vehicle on-board unit as recited in claim 1, wherein
the voice message download section is further configured to download additional voice messages in an additional voicemail account of the user linked to the roadside unit through the short range wireless communication section, and
the voice message storing section configured to store the additional voice messages downloaded by the voice message download section.

17. The vehicle on-board unit as recited in claim 16, wherein
the notification section is further configured to notify the user that the additional voice messages were downloaded and stored at the notification timing set in the notification timing setting section.

18. The vehicle on-board unit as recited in claim 16, wherein
the notification timing setting section is further configured to set an additional notification timing for notifying the user that the additional voice messages were downloaded and stored according to the operational conditions of the host vehicle, and
the notification section is further configured to notify the user that the additional voice messages were downloaded and stored at the additional notification timing set in the notification timing setting section.

19. The vehicle on-board unit as recited in claim 18, wherein
the notification timing setting section is further configured to allow the user to select the operational conditions for setting the notification timing and the operational conditions for setting the additional notification timing.

20. The vehicle on-board unit as recited in claim 1, wherein
the notification section includes at least one of a display portion configured and arranged to visually notify the user that the voice messages were downloaded and stored, and an audio portion configured and arranged to aurally notify the user that the voice messages were downloaded and stored.
